(19) United States
(12) Patent Application Publication
(10) Pub. No.: US 2026/0147400 A1
(43) Pub. Date: May 28, 2026

(54) PART INVARIANT PEAK POWER MANAGEMENT

(71) Applicant: NVIDIA Corporation, Santa Clara, CA (US)

(72) Inventors: Vandana Bansal, Milpitas, CA (US); Brian Smith, Mountain View, CA (US); Jun Gu, San Jose, CA (US); Vishal Mehta, Pleasanton, CA (US)

(73) Assignee: NVIDIA Corporation, Santa Clara, CA (US)

(21) Appl. No.: 18/962,199

(22) Filed: Nov. 27, 2024

(51) Int. Cl. G06F 1/324

(52) U.S. Cl. CPC G06F 1/324

(57) ABSTRACT

In various examples, systems and methods are disclosed relating to part-invariant peak power management. One or more circuits can receive a plurality of instructions for a graphics processing device. The plurality of instructions can correspond to a respective plurality of power consumption values. The one or more circuits can determine that the respective plurality of power consumption values cause a threshold to be exceeded during a time period. The one or more circuits can generate a control signal to control a clock signal for the graphics processing device responsive to determining that the respective plurality of power consumption values cause the threshold to be exceeded.

### BACKGROUND

Graphics processing units (GPUs) and other processor types consume varying amounts of power depending on their workload. Conventional power management techniques in GPU and other devices often rely on current sensors to monitor peak electric current for one or more power rails of the device, initiating protective actions such as current limiting or device shutdown when peak current exceeds a predetermined threshold for a specified duration. However, this approach is insufficient for real-time or safety-oriented systems due to the non-deterministic nature of throttling parts within the GPU or other processor types, which can lead to unpredictable performance degradation.

### SUMMARY

The electrical design point (EDP) for graphics processing devices specify the per-rail peak electric current limit that is to be allowed before engaging different protection actions. Such protection actions may include current limiting or device shutdown. Limiting the peak electric current of a device reduces the impact of heat produced by the device during its operation, preventing potential damage or failure. In certain GPU devices and workloads, the peak electric current may be significantly larger than continuous/average electric current drawn during normal operation. Peak current consumption may be allowable for certain time periods for certain applications before device power consumption can be reduced to prevent device failure.

Conventional approaches for managing electric currents in GPU devices involve using current sensors to measure peak current for one or more power rails of the device. When peak current is detected for greater than a predetermined amount of time, the frequency and/or voltage of the GPU device is throttled to reduce overall device power consumption. However, merely monitoring the peak current using current sensors is insufficient for real-time or safety-oriented systems because it results in non-deterministic throttling of parts in the GPU due to the variation in power across the distribution of parts. To address these issues, the systems and methods described herein provide part-invariant power management, which can manage power consumption of different GPU parts/devices at the instruction level. To implement these techniques, device-level instructions can be assigned to different power-consumption categories, depending on the expected amount of power to be consumed by executing each instruction. These categories may be defined according to GPU device-type, in some implementations. Power consumption categories are tracked by the GPU device when executing instructions.

At least one aspect relates to one or more processors. The one or more processors can include one or more circuits. The one or more circuits can receive a plurality of instructions for a graphics processing device. The plurality of instructions can correspond to a respective plurality of power consumption values. The one or more circuits can determine that the respective plurality of power consumption values cause a threshold to be exceeded during a time period. The one or more circuits can generate a control signal to control a clock signal for the graphics processing device responsive to determining that the respective plurality of power consumption values cause the threshold to be exceeded.

In some implementations, the one or more circuits can determine an average or aggregated value of the respective plurality of power consumption values according to a sliding window size. In some implementations, the one or more circuits can determine that the average or aggregated value exceeds the threshold during the time period. In some implementations, the one or more circuits can receive a signal to modify the sliding window size. In some implementations, the one or more circuits can update the sliding window size according to the signal.

In some implementations, the one or more circuits can receive a signal to modify the threshold. In some implementations, the one or more circuits can update the threshold according to the signal. In some implementations, the graphics processing device operates on a first clock domain and the one or more circuits operate at least partially on a second clock domain. In some implementations, a first power consumption value of the plurality of power consumption values corresponds to a high-power instruction and a second power consumption value of the plurality of power consumption values corresponds to a low power instruction.

In some implementations, the one or more circuits can generate the control signal according to a table of stepping values. In some implementations, the one or more circuits can control a frequency of the clock signal according to the control signal. In some implementations, the one or more circuits can receive a second plurality of instructions corresponding to a respective second plurality of power consumption values. In some implementations, the one or more circuits can determine that the respective second plurality of power consumption values do not cause the threshold to be exceeded during a second time period. In some implementations, the one or more circuits can generate a second control signal for the graphics processing device to increase a frequency of the clock signal. In some implementations, the graphics processing device comprises a graphics processing cluster (GPC).

At least one aspect relates to a system. The system can include a streaming multiprocessor. The streaming multiprocessor can provide a plurality of power consumption values corresponding to a plurality of instructions. The system can include a graphics processing cluster (GPC). The GPC can receive the plurality of power consumption values from the streaming multiprocessor. The GPC can calculate a rolling average of the plurality of power consumption values according to a window period. The GPC can generate a control signal for a clock divider circuit of the GPC based at least on a comparison of the rolling average and a threshold.

In some implementations, the GPC can store the window period in a first register of the GPC and can store the threshold in a second register of the GPC. In some implementations, the GPC comprises a comparator. In some implementations, the GPC can generate the comparison of the rolling average and a threshold using the comparator. In some implementations, the GPC can generate the rolling average of the plurality of power consumption values within a fixed clock domain. In some implementations, the GPC can provide the plurality of power consumption values to the fixed clock domain via a dual-clock first-in-first-out (FIFO) circuit. In some implementations, the GPC can accumulate the plurality of power consumption values into a step value. In some implementations, the GPC can store the step value in a first-in-first-out (FIFO) circuit having a size selected according to the window period. In some implementations, the GPC can calculate the rolling average of the plurality of power consumption values based at least on an output of the FIFO.

At least one aspect is related to a method. The method can include receiving a plurality of instructions for a graphics processing device. The plurality of instructions can correspond to a respective plurality of power consumption values. The method can include determining that the respective plurality of power consumption values cause a threshold to be exceeded during a time period. The method can include generating a control signal to control a clock signal for the graphics processing device responsive to determining that the respective plurality of power consumption values cause the threshold to be exceeded.

In some implementations, the method can include determining an average or aggregated value of the respective plurality of power consumption values according to a sliding window size. In some implementations, the method can include determining that the average or aggregated value exceeds the threshold during the time period. In some implementations, the method can include receiving a signal to modify the sliding window size. In some implementations, the method can include updating the sliding window size according to the signal.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a vision language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for implementing part-invariant peak power management are described in detail below with reference to the attached drawing figures, wherein:

FIG. 1 is a block diagram of an example system for implementing part invariant peak power management, in accordance with some embodiments of the present disclosure;

FIG. 2 depicts an example diagram showing how different graphics processing instructions can be assigned to different power consumption values, in accordance with some embodiments of the present disclosure;

FIG. 3 is a flow diagram of an example of a method for implementing part invariant peak power management, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

This disclosure relates to systems and methods for managing peak power consumption in graphics processing devices. Although primarily described with respect to graphics processing devices (e.g., GPUs), this is not intended to be limiting, and the systems and methods described herein may be used for any other processing device type(s) without departing from the scope of the present disclosure.

The EDP for graphics processing devices, such as GPUs, can define the per-rail peak electric current limit that is to be allowed before engaging different protection actions. Such protection actions may include current limiting or device shutdown. Limiting the peak electric current of a device reduces the impact of heat produced by the device during its operation, preventing potential damage or failure.

In certain GPU devices and workloads, the peak electric current may be significantly larger than continuous/average electric current drawn during normal operation. The ratio between peak electric current and continuous electric current in GPU devices creates significant design complexity to accommodate the electric current requirements for certain workloads while limiting risk of device failure or damage due to thermal load. In general, peak current consumption may be allowable for a predetermined amount of time before device power consumption can be reduced to prevent device failure.

Conventional approaches for managing electric currents in GPU devices involve using a current sensor to measure peak current for one or more power rails of the device. When peak current is detected for greater than a predetermined amount of time, the frequency of the GPU device is throttled to reduce overall device power consumption. However, merely monitoring the peak current using current sensors is insufficient for real-time or safety-oriented systems because it results in non-deterministic throttling of parts in the GPU.

To address these issues, the systems and methods described herein provide part-invariant power management, which can manage power consumption of different GPU parts/devices at the instruction level. To implement these techniques, device-level instructions can be assigned to different power-consumption categories, depending on the expected amount of power to be consumed by executing each instruction. These categories may be defined according to GPU device-type, in some implementations. Power consumption categories can be tracked by the GPU device when executing instructions.

A moving average of the number of high-power consuming instructions is calculated over a predetermined window of time. If the average number of instructions that are to result in high power consumption exceeds a predetermined threshold within the time window, the clock speed of the GPU device can be adjusted to reduce overall power consumption of the device. As the power consumption of the device is determined using the expected power consumption of device instructions themselves, rather than current monitoring, the GPU device is throttled in a deterministic manner. Different thresholds and time windows can be selected according to different power modes of the GPU devices.

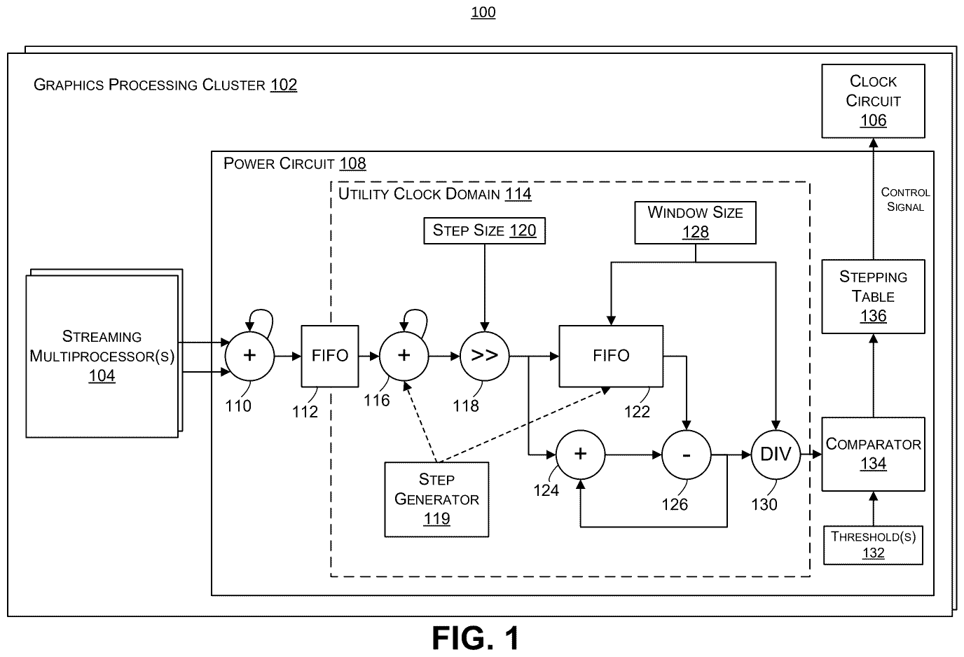

With reference to FIG. 1, FIG. 1 is an example computing environment including a system 100 for implementing part-invariant peak power management, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 may be included as part of a graphics processing device and is shown as including at least one graphics processing cluster (GPC) 102. The GPC 102 is shown as including one or more streaming multiprocessors 104 and a power circuit 108. In some implementations, the system 100 may include multiple GPCs 102, each of which may include their own set of streaming multiprocessors 104, a power circuit 108, and at least one clock circuit 106. The clock circuit 106 can generate and vary a clock signal for various components of the GPC 102. The clock circuit 106 can adjust the frequency of the clock signal in response to a control signal generated by the power circuit 108, as described in further detail herein. The clock circuit 106 can adjust the frequency of the clock signal during device operation to maintain operational stability of the GPC 102.

In some implementations, the clock circuit 106 can include a load divider, which can divide the clock signal of the GPC 102 according to the control signal generated by the power circuit 108. The control signal from the power circuit 108 can indicate the division ratio by which the clock signal of the GPC 102 is to be divided. As the power consumption of the GPC 102 is a function of the frequency of the clock signal provided by the clock circuit 106, reducing the frequency of the clock signal can reduce the power consumption of the GPC 102 such that peak power consumption does not exceed device limitations. As each GPC 102 implements a respective power circuit 108 that reduces power consumption based on estimated power of the instructions it is to execute, the power consumption of each GPC 102 can be deterministically managed by the power circuit 108.

Each of the GPCs 102 of the system 100 can independently implement peak power management using a corresponding power circuit 108. The power circuit 108 receives power consumption values from the one or more streaming multiprocessors 104 of the GPC 102. Each streaming multiprocessor 104 can execute instructions and perform computations for the GPC 102. Each streaming multiprocessor 104 can include any number of processing cores that are each capable of executing multiple threads concurrently. The streaming multiprocessors 104 can include any number of processing cores, which may include memory elements or logical circuits suited to different types of processing operations, including tensor processing operations and/or graphics processing operations.

The streaming multiprocessors 104 can receive processing instructions from a command processor of a graphics processing device (e.g., a graphics processing unit (GPU), etc.). Once received, the streaming multiprocessors 104 can decode instructions and can issue the instructions to suitable processing units of the streaming multiprocessors 104, which subsequently perform the operations to carry out the instruction(s). When the instruction is fetched/received from the command processor, the streaming multiprocessors 104 can provide one or more power consumption values that are assigned to the instruction to the power circuit 108. Each streaming multiprocessor 104 can provide the power consumption values to the GPC 102 independently for aggregation, as shown.

The power consumption values provided by the streaming multiprocessors 104 can be indicative of the expected power consumption associated with executing the corresponding instructions. In some implementations, the power consumption values may be selected from a set of possible power consumption weight values (e.g., power consumption categories) stored in the memory of the streaming multiprocessors 104. In such implementations, each instruction type can be associated or mapped to a corresponding power consumption value that reflects the anticipated power consumption and/or during execution. The power consumption value may be stored as an integer value or any other type of value that can be aggregated by the components of the power circuit 108 as described in further detail herein.

In some implementations, the power consumption values may be weight values corresponding to the contribution of the instruction to the peak power of the GPC 102 while executing the instruction. Such weights may be pre-calculated values determined based on the power consumption characteristics of the instruction and may vary depending on the type of operation being performed and/or which components are involved in the processing operations. For instance, tensor processing operations may consume more power than simple arithmetic operations, and these differences can be reflected in the assigned power consumption values.

The power consumption values may be pre-assigned to different types of instructions based on the estimated, simulated, or measured power consumption patterns of each instruction when executed by the corresponding GPC 102. In some implementations, determining the power consumption may be estimated based on the types of components of the GPC 102 that are active when executing the instruction. In some implementations, the estimated power consumption of each instruction may be determined based on power measurements previously captured using testing systems used to evaluate the performance of GPCs 102 under various load conditions. In some implementations, simulations or estimations of power consumption may be determined without capturing power measurements from similar devices (e.g., devices having the same architecture as the GPC 102). For example, register-level or component-level simulation may be simulated using a sequence of test signals that carry out different instructions. Furthering this example, the power consumption values of each instruction type can be estimated based on signals from simulations that indicate which registers or components are activated, the time that the registers or components are activated, and/or the allowable peak power consumption of the device being simulated.

Once power consumption values are established, the power consumption values (and corresponding mappings to different instructions) can be stored in one or more lookup tables or similar data structures within the memory of the streaming multiprocessors 104. In some implementations, driver updates, firmware updates, or other changes in software may be used to update or tune the power consumption values assigned to different instruction types. For example, power consumption values may be updated and/or refined over time as additional data is collected from execution of instructions within different GPCs 102 across different graphics processing devices.

The power circuit 108 can include an aggregator 110 that can aggregate (e.g., sum, combine) the power consumption values from multiple streaming multiprocessors 104. For example, multiple streamlining multiprocessors 104 may receive and/or fetch instructions in parallel and can simultaneously (or nearly simultaneously) provide corresponding power consumption values to the aggregator 110. The power circuit 108 can receive and/or aggregate (e.g., sum) power consumption values from multiple streaming multiprocessors 104 to determine an expected combined power consumption value of the multiple streaming multiprocessors 104 of the GPC 102. In some implementations, each streaming multiprocessor 104 can provide an indication of an instruction added to its pipeline, along with the corresponding power consumption value associated with that instruction, to the aggregator 110 of the power circuit 108.

In some implementations, rather than reporting individual power consumption values for each instruction, each streaming multiprocessor 104 can provide an indication of the instruction to the power circuit 108 upon the instruction being added to its processing pipeline. In such implementations, upon receiving an indication of an instruction, the power circuit 108 can then identify one or more corresponding power consumption values from its own memory, which may include a lookup table or similar data structure mapping each instruction type to its respective power consumption value. As described herein, such lookup tables or data structures can be pre-populated with power consumption values based on the estimated power consumption characteristics of each instruction type.

The aggregator 110 of the power circuit 108 can sum the power consumption values corresponding to the instructions in the pipeline of the streaming multiprocessors 104. The aggregated power consumption values can be provided as input to a dual-clock first-in-first-out (FIFO) circuit 112, as shown. The aggregator 110 may include any number of adder circuits, registers, or other logical elements to sum, store, and/or accumulate power consumption values from the streaming multiprocessors 104. In some implementations, the aggregator 110 may aggregate multiple power consumption values across multiple clock cycles, for example, if the dual-clock FIFO circuit 112 is full or cannot receive additional input data. In such implementations, the aggregator 110 can accumulate multiple cycles of power consumption values until the accumulated value can be provided as input to the dual-clock FIFO 112.

The GPC 102 and the power circuit 108 (or portions thereof) can operate on different clock domains. The dual-clock FIFO 112 can act as a bridge between the clock domain of the GPC 102 and a fixed utility clock domain 114 of the power circuit 108. The dual-clock FIFO 112 can receive power consumption values from the aggregator 110, which operates in the clock domain of the GPC 102 and can transfer these values to the components of the power circuit 108 operating on the fixed utility clock domain 114. The dual-clock FIFO may receive clock signals from both the GPC clock and a utility clock of the fixed utility clock domain 114 to facilitate synchronization of power consumption data between the two clock domains.

The utility clock domain 114 can be fixed and not necessarily affected by changes to the GPC clock, which can govern/control/affect the rate at which operations of the GPC 102 are executed. The utility clock domain 114 can be fixed to ensure that a rolling average of power consumption values can be calculated by components of the power circuit 108 over a fixed time period, independent of the operational clock domain of the GPC 102. The fixed utility clock domain 114 implemented by the power circuit 108 can maintain a consistent timing reference relative to a potentially changing GPC clock, such that the average expected power consumption can be accurately calculated over a provided window period (e.g., as a function of the step size 120 and the window size 128, as described in further detail herein).

The combined power consumption values stored in the dual-clock FIFO 112 can be dequeued and aggregated/accumulated by a second aggregator 116 of the power circuit 108. In some implementations, the second aggregator 116 can dequeue and/or accumulate a power consumption value from the dual-clock FIFO 112 each clock cycle (or every predetermined number of clock cycles) until a signal from a step generator 119 of the power circuit 108 is received. The step generator 119 can generate a signal that causes the sum accumulated by the second aggregator 116 to be provided as input to a second FIFO 122 via an input register 118. The step generator 119 can generate the step signal at regular intervals, as provided by the step size 120, which is stored in one or more registers of the power circuit 108. The register storing the step size 120 can be updated or otherwise initialized via firmware, drivers, or other input to the GPC 102. For example, the GPC 102 can receive a signal to update the registers storing the step size 120 and can store the updated step size 120 in the one or more registers. The step size 120 can represent the number of clock cycles of the utility clock domain 114 over which power consumption values are to be accumulated by the second aggregator 116. The step generator 119 can ensure that the second aggregator 116 accumulates power consumption values for the duration specified by the step size 120, thereby maintaining a consistent step size for the rolling average calculation performed using the second FIFO 122.

The second FIFO 122 can be initialized to include a size (e.g., possible number of stored elements) equal to a window size 128, which may be stored in one or more registers of the power circuit 108. The register(s) storing the window size 128 can be updated or otherwise initialized via firmware, drivers, or other input to the GPC 102. For example, the GPC 102 can receive a signal to update the registers storing the window size 128 and can store the updated window size 128 in the one or more registers. The window size 128 can represent the number of steps of accumulated power consumption values that are to be stored in a window for the rolling average calculation. The initialization of the second FIFO 122 can be performed by setting the capacity of the second FIFO 122 to accommodate the number of elements specified by the window size 128. Each register in the second FIFO 122 can be initialized to a default value, in some implementations. The second FIFO 122 can be used to maintain aggregated steps of power consumption values generated by the second aggregator 116 for a window period determined as a function of the step size 120, the window size 128, and the frequency of the utility clock of the utility clock domain 114.

The input register 118 can receive the accumulated power consumption values from the second aggregator 116 and provide these values as input to the second FIFO 122. The input register 118 can store the accumulated power consumption values temporarily before transferring them to the second FIFO 122. This transfer can occur in response to a signal from the step generator 119, which ensures that the power consumption values are provided to the second FIFO 122 at regular intervals corresponding to the step size 120. The input register 118 can also provide the accumulated power consumption values as input to a third aggregator 124.

The third aggregator 124, a subtraction circuit, the second FIFO 122, and/or a division circuit 130 can calculate a rolling average of the power consumption step values. Each of the third aggregator 124, the subtraction circuit 126, and the division circuit 130 can include any number of registers or logical elements that carry out addition, subtraction, and addition operations of numerical values to calculate the rolling average of power consumption over the window period.

As shown, the third aggregator 124 can receive a step value for a current time period and the output of the second subtraction circuit 126. The subtraction circuit 126 can generate a difference between the output of the third aggregator circuit 124 and an output of the second FIFO 122, thereby calculating a sum of a number of steps equal to the window size 128 each clock cycle. For each additional step that is generated according to the step generator 119, the second FIFO 122 can dequeue the oldest step value from the FIFO and can subtract it from the aggregated sum generated by the third aggregator 124. The aggregated sum generated by the third aggregator 124 can be equal to the sum of window size 128 prior steps plus the latest step provided by the input register 118. The output of the subtraction circuit 126 is therefore the sum of N prior steps (where N is equal to the window size 128), plus the latest generated step provided by the input register 118, minus the oldest step value dequeued from the second FIFO 122. As the oldest step value is dequeued from the second FIFO 122, the input register stores the latest step in the second FIFO 122.

As each next step is generated and provided by the input register 118, the output of the subtraction circuit 126 is the sum of N steps (where N is equal to window size 128), which can be the value of the latest step provided by the input register 118 plus the values of N−1 prior steps. The division circuit 130 can divide the output of the subtraction circuit 126 by the window size 128, generating a rolling average of power consumption values over the window period. The rolling average can be updated each time an additional step is generated according to the output of the step generator 119.

The rolling average output of the division circuit 130 provided as input to a comparator 134 with one or more thresholds 132 to determine whether to reduce the clock frequency of the GPC 102. The threshold(s) 132 can be stored in one or more registers of the GPC 102. The register(s) storing the threshold 132 can be updated or otherwise initialized via firmware, drivers, or other input to the GPC 102. For example, the GPC 102 can receive a signal to update the registers storing the threshold(s) 132 and can store the updated threshold(s) 132 in the one or more registers. In this example, the comparator 134 is shown as being outside of the utility clock domain 114. The division circuit 130 can provide the rolling average output to the comparator 134 via one or more synchronization circuits (e.g., register chains, dual-clock FIFO, etc.). In some implementations, the comparator 134 and the registers storing the threshold 132 can be included within the utility clock domain 114.

The threshold(s) 132 can include a predetermined value that represents the maximum allowable average power consumption over the window period. The comparator 134 can include any number of logical elements, such as comparators, registers, or other circuitry, to perform the comparison operation. The comparator 134 can receive the rolling average from the division circuit 130 and the threshold 132 as inputs and generate an output signal based on the comparison result. If the rolling average exceeds the threshold 132, the comparator 134 can generate a signal indicating that the power consumption is above the threshold, causing a stepping table 136 to generate a control signal for the clock circuit 106.

The comparator 134 can implement hysteresis to prevent rapid toggling between states when the rolling average is near the threshold 132. Hysteresis can be implemented using a high threshold 132 and a low threshold 132. When the rolling average exceeds the high threshold 132, the comparator 134 can generate a signal for the stepping table 136 indicating that the clock frequency of the GPC 102 is to be reduced. Once the rolling average falls below the low threshold 132, the comparator 134 can generate a signal for the stepping table 136 indicating that the clock frequency of the GPC 102 is to be restored to its normal rate. The high threshold and the low threshold can be stored in one or more registers as part of the threshold(s) 132 and can be set such that the difference between them provides a margin of stability, preventing the comparator 134 from toggling rapidly between states when the rolling average fluctuates around the threshold 132. The output of the comparator 134 is provided to a stepping table 136.

The stepping table 136 can output one or more control signals to gradually step down the clock frequency of the GPC 102 when the rolling average of power consumption exceeds the threshold 132. The stepping table 136 can include a lookup table or similar data structure that maps the output of the comparator 134 to a sequence of control signals. Each control signal can correspond to a specific division ratio for the clock signal of the GPC 102. The stepping table 136 can generate control signals in a predetermined order, such that the clock frequency is reduced in a series of steps rather than abruptly. The stepping table 136 can be initialized or updated via firmware, drivers, or other input to the GPC 102, in some implementations.

The control signals generated by the stepping table 136 can be provided to a load divider of the clock circuit 106. The load divider can include any number of logical elements, such as dividers, registers, or other circuitry, to divide the clock signal according to the output of the stepping table 136. For example, the load divider can divide the clock signal by a factor of 2, 4, or any other predetermined factor, depending on the control signal received from the stepping table 136. As the clock frequency is reduced, the power consumption of the GPC 102 also decreases, thereby preventing the power consumption from exceeding the threshold 132. The gradual reduction in clock frequency can be achieved by incrementally increasing the division ratio of the clock signal. For example, the stepping table 136 can generate a sequence of control signals that incrementally increase the division ratio, such as from 1 to 2, then from 2 to 4, and so on.

The stepping table 136 can also generate control signals to gradually restore the clock frequency of the GPC 102 when the rolling average of power consumption falls below the threshold 132 (e.g., the low threshold). The stepping table 136 can include a reverse sequence of control signals that correspond to reducing the division ratio of the clock signal. For example, if the clock signal was divided by a factor of 4, the stepping table 136 can generate control signals to reduce the division ratio back to 2, and then to 1, thereby restoring the clock frequency to its original value. This gradual restoration of the clock frequency ensures that the GPC 102 returns to full operational capacity without causing a sudden increase in power consumption that could exceed the threshold 132.

The system 100 can include any number of GPCs 102, each of which can independently and deterministically limit power consumption according to the techniques described herein. As the step size 120, the window size 128, the thresholds 132, and the power consumption values assigned to each instruction are configurable, the techniques described herein can be implemented by any suitable graphics processing device that executes instructs. For example, any type of graphics processing devices may include a power circuit 108 and clock circuit 106, which need not necessarily be included in a graphics processing cluster 102 or receive instructions or power values from one or more streaming multiprocessors 104. For example, any graphics processing device that executes instructions (which can be associated with corresponding power consumption values) can include a power circuit 108 that operates using similar techniques described herein to control a clock circuit 106 to deterministically control power consumption by the graphics processing device.

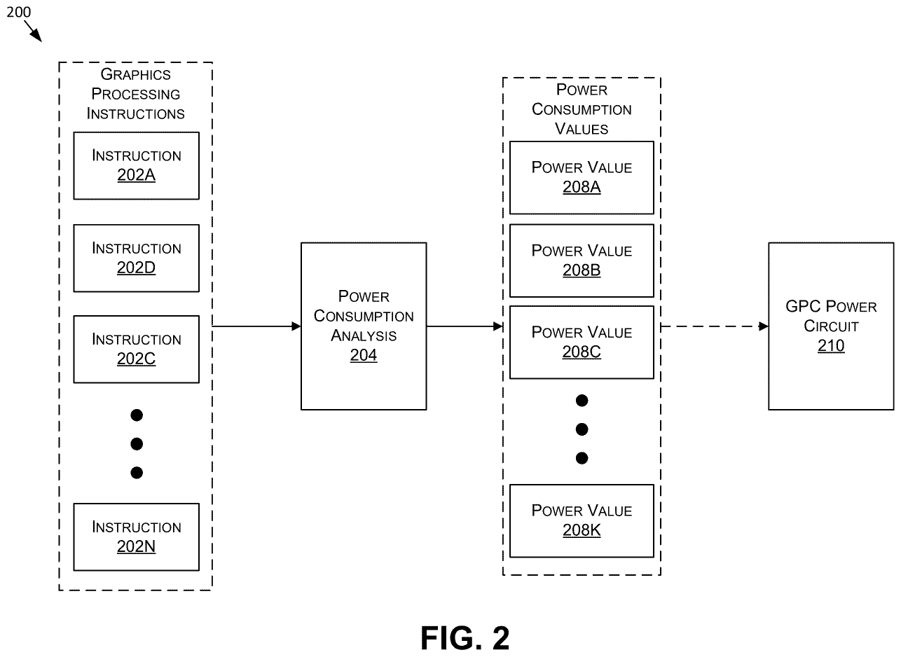

Referring to FIG. 2 in the context of the components described in connection with FIG. 1, depicted is an example diagram 200 showing how different graphics processing instructions 202A-202N (sometimes generally referred to as “graphics processing instructions 202”) can be assigned to different power consumption values 208A-208K (sometimes generally referred to as “power consumption values 208”), in accordance with some embodiments of the present disclosure. As described herein, power consumption can be deterministically limited by monitoring the instructions in the pipeline of a GPC (e.g., the GPC 102). In this example, each of the graphics processing instructions 202 can be assigned a power consumption value 208 using a power consumption analysis process 204.

The graphics processing instructions 202 can include any type of instruction that may be executed by one or more streaming multiprocessors 104 of a graphics processing device. Example instructions include tensor processing instructions, floating-point arithmetic operations, shader operations, or any other type of instruction that may be executed by a graphics processing device. The power consumption analysis process 204 can implement any suitable approach to estimate the dynamic power consumption of a given instruction 202. Examples of different power consumption analysis processes 204 can include simulations, real-time measurements, or modeling/estimation.

In one example, graphics processing instructions 202 that involve a larger number of processing units, memory elements, or other components of the graphics processing device can be estimated to use a high amount of dynamic device power. Such instructions 202 can be assigned a power value 208 that indicates the instruction 202 is a high-power instruction 202. In another example, graphics processing instructions 202 involving arithmetic operations may involve fewer processing units and less memory access, resulting in lower power consumption. Such instructions 202 can be assigned a power value 208 that indicates the instruction 202 is a low power instruction 202.

In some implementations, the power consumption analysis process 204 can include performing empirical measurements of power consumption during the execution of different instructions 202 on a target device. For example, a test system can be used to execute a set of graphics processing instructions 202 on a target device, and the resulting power consumption of the target device can be measured using current sensors or other monitoring devices. The power consumption values 208 can be recorded and/or averaged over multiple executions to ensure accuracy. This process can be repeated for different instructions 202 to generate empirical power consumption values 208 for each instruction type.

In some implementations, the power consumption analysis process 204 can include performing simulations of the execution of each instruction 202 on a target device. For example, a simulation tool can be used to model the execution of each type of instruction 202. The simulation can report operations performed by each component of the target device, which can be used to calculate or estimate the power consumption of the target device during the simulation. The simulation can capture the activation of various components, such as processing cores, memory elements, and interconnect circuits, and the power consumption associated with each component. The simulation results can be aggregated to determine the total power consumption of the target device during the execution of the tensor processing operation. This process can be repeated for different instructions 202 to assign a corresponding power consumption value 208 for each instruction type.

In some implementations, the power consumption values 208 can be categorized into distinct power consumption categories, each assigned a numerical weight value corresponding to its relative power consumption. These categories can be defined based on the estimated or measured power consumption characteristics of different types of instructions 202. For example, a low-power category can be assigned a relatively lower weight value, indicating minimal power consumption, while a high-power category can be assigned a larger weight value, indicating significantly higher power consumption. The power circuit 108 of FIG. 1 can process these weight values to calculate the rolling average of power consumption over a window period, as described herein. In some implementation, the instructions 202 can be assigned to a power consumption value 208 based on the ratio of the dynamic power consumed by the instruction to the allowable peak power of the target device.

Although K power values 208A-208K are shown in the diagram 200, it should be understood that any number of power values 208 may be generated and assigned to any number of graphics processing instructions 202A-202N. Once power values 208 are assigned to graphics processing instructions 202, the power values 208 can be provided (e.g., via driver or firmware) to one or more GPC power circuits 210 (e.g., the power circuits 108) to implement the deterministic peak power management techniques described herein.

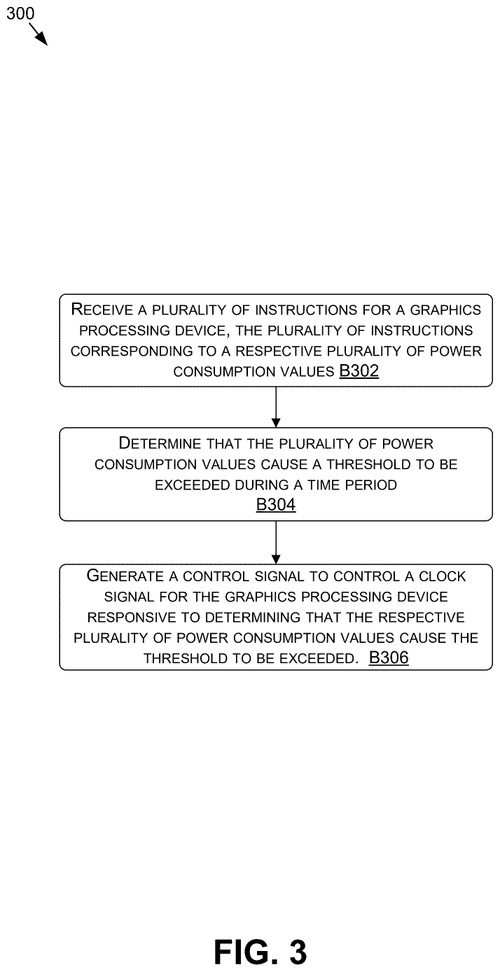

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by any number of circuits, logical devices, an application, a service or hosted service (standalone or in combination with another hosted service), or a plug-in to another product, to name a few. In addition, method 300 is described, by way of example, with respect to the system 100 of FIG. 1. However, this method may additionally or alternatively be executed by any one system, or any combination of systems, including, but not limited to, those described herein.

FIG. 3 is a flow diagram showing a method 300 for implementing part-invariant peak power management, in accordance with some embodiments of the present disclosure. The method 300, at block B302, includes receiving instructions (e.g., instructions 202) for a graphics processing device (e.g., a GPU, the GPC 102, streaming multiprocessors 104, etc.). The instructions can correspond to one or more power consumption values (e.g., power consumption values 208). The instructions may be provided from a command processor of the graphics processing device. The power consumption values may include weight values, and may be sored in one or more registers, lookup tables, or other data structures of the graphics processing device. In some implementations, the power values can be provided to a power circuit of the graphics processing device. In some implementations, the power values can be retrieved from memory of the power circuit by performing a lookup using the received instructions.

The method 300, at block B304, includes determining that the plurality of power consumption values cause a threshold (e.g., the threshold 132) to be exceeded during a time period. To do so, an average or aggregated value of the power consumption values can be determined according to a sliding window size (e.g., the window size 128). The average or aggregated value can be compared to the threshold to determine whether the threshold is exceeded. In some implementations, the average can be a rolling average calculated according to a step size (e.g., the step size 120) and a window size (e.g., the window size 128). The window size and/or the step size can be stored in one or more registers of the graphics processing device and can be modified in response to corresponding signals. The rolling average can be calculated using a power circuit (e.g., the power circuit 108), which may operate at least partially on a fixed utility clock domain (e.g., the utility clock domain 114). Operating on a fixed utility clock domain enables the window period used by the power circuit to remain consistent even when the clock governing operations of the graphics processing device is changed to limit power consumption.

The method 300, at block B306, includes generating a control signal to control a clock signal for the graphics processing device responsive to determining that the respective plurality of power consumption values cause the threshold to be exceeded. The control signal may be generated by a stepping table upon receiving a signal from a comparator that indicates the threshold is exceeded. The stepping table can gradually step down the frequency of the clock governing operations of the graphics processing device. In some implementations, the stepping table can divide the clock by a predetermined integer value. In some implementations, upon further instructions indicating that the power consumption no longer exceeds the threshold, a second control signal can be generated that gradually increases the clock frequency to the normal operating frequency of the graphics processing device.

The systems and methods described herein may be used for a variety of purposes, by way of example and without limitation, for circuit layout definition, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs), systems for performing light transport simulation, systems for performing collaborative content creation for 3D assets, systems implemented at least partially using cloud computing resources, and/or other types of systems.

### Example Computing Device

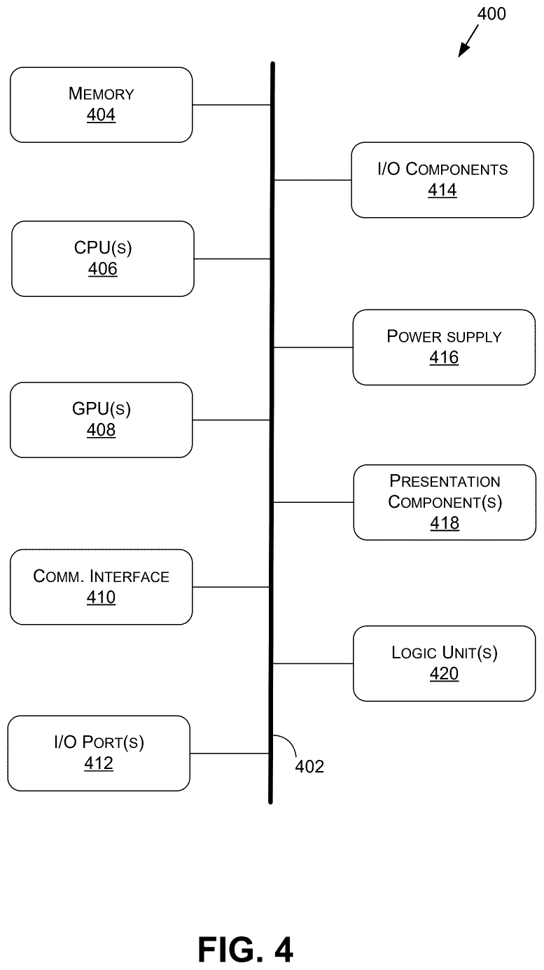

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

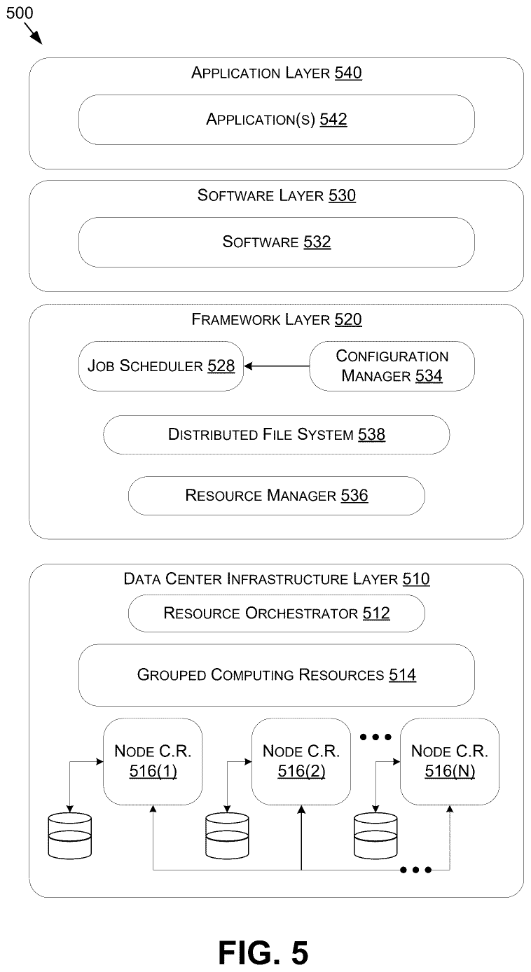

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4 - e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive a plurality of instructions for a graphics processing device, the plurality of instructions corresponding to a respective plurality of power consumption values;
determine that the respective plurality of power consumption values cause a threshold to be exceeded during a time period; and
generate a control signal to control a clock signal for the graphics processing device responsive to determining that the respective plurality of power consumption values cause the threshold to be exceeded.

2. The one or more processors of claim 1, wherein the one or more circuits are to:
determine an average or aggregated value of the respective plurality of power consumption values according to a sliding window size; and
determine that the average or aggregated value exceeds the threshold during the time period.

3. The one or more processors of claim 2, wherein the one or more circuits are to:
receive a signal to modify the sliding window size; and
update the sliding window size according to the signal.

4. The one or more processors of claim 1, wherein the one or more circuits are to:
receive a signal to modify the threshold; and
update the threshold according to the signal.

5. The one or more processors of claim 1, wherein the graphics processing device operates on a first clock domain and the one or more circuits operate at least partially on a second clock domain.

6. The one or more processors of claim 1, wherein a first power consumption value of the plurality of power consumption values corresponds to a high power instruction and a second power consumption value of the plurality of power consumption values corresponds to a low power instruction.

7. The one or more processors of claim 1, wherein the one or more circuits are to:
generate the control signal according to a table of stepping values; and
control a frequency of the clock signal according to the control signal.

8. The one or more processors of claim 1, wherein the one or more circuits are to:
receive a second plurality of instructions corresponding to a respective second plurality of power consumption values;
determine that the respective second plurality of power consumption values do not cause the threshold to be exceeded during a second time period; and
generate a second control signal for the graphics processing device to increase a frequency of the clock signal.

9. The one or more processors of claim 1, wherein the graphics processing device comprises a graphics processing cluster (GPC).

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a vision language model (VLM);
a system for performing generative AI operations using a multimodal language model;
a system for generating synthetic data;
a system incorporating one or more virtual machines (VMs);
a system implemented at least partially in a data center; or
a system implemented at least partially using cloud computing resources.

11. A system, comprising:
a streaming multiprocessor to provide a plurality of power consumption values corresponding to a plurality of instructions;
a graphics processing cluster (GPC) to:
receive the plurality of power consumption values from the streaming multiprocessor;
calculate a rolling average of the plurality of power consumption values according to a window period; and
generate a control signal for a clock divider circuit of the GPC based at least on a comparison of the rolling average and a threshold.

12. The system of claim 11, wherein the GPC is to:
store the window period in a first register of the GPC and store the threshold in a second register of the GPC.

13. The system of claim 11, wherein the GPC comprises a comparator, and the GPC is to:
generate the comparison of the rolling average and a threshold using the comparator.

14. The system of claim 11, wherein the GPC is to:
generate the rolling average of the plurality of power consumption values within a fixed clock domain.

15. The system of claim 14, wherein the GPC is to:
provide the plurality of power consumption values to the fixed clock domain via a dual-clock first-in-first-out (FIFO) circuit.

16. The system of claim 11, wherein the GPC is to:
accumulate the plurality of power consumption values into a step value;
store the step value in a first-in-first-out (FIFO) circuit having a size selected according to the window period; and
calculate the rolling average of the plurality of power consumption values based at least on an output of the FIFO.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a vision language model (VLM);
a system for performing generative AI operations using a multimodal language model;
a system for generating synthetic data;
a system incorporating one or more virtual machines (VMs);
a system implemented at least partially in a data center; or a system implemented at least partially using cloud computing resources.

18. A method, comprising:
receiving a plurality of instructions for a graphics processing device, the plurality of instructions corresponding to a respective plurality of power consumption values;
determining that the respective plurality of power consumption values cause a threshold to be exceeded during a time period; and
generating a control signal to control a clock signal for the graphics processing device responsive to determining that the respective plurality of power consumption values cause the threshold to be exceeded.

19. The method of claim 18, further comprising:
determining an average or aggregated value of the respective plurality of power consumption values according to a sliding window size; and
determining that the average or aggregated value exceeds the threshold during the time period.

20. The method of claim 19, further comprising:
receiving a signal to modify the sliding window size; and
updating the sliding window size according to the signal.
